(19) United States
(12) Patent Application Publication
(10) Pub. No.: US 2008/0109122 A1
(43) Pub. Date: May 8, 2008

(54) Work machine control using off-board information

(76) Inventors: Alan L. Ferguson, Peoria, IL (US); Steven W. O'Neal, Bartonville, IL (US); Paul W. Bierdeman, East Peorla, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/289,455

(22) Filed: Nov. 30, 2005

(51) Int. Cl. G06F 17/00; A01B 69/00; G05D 1/00; G06F 19/00

(52) U.S. Cl. 701/2; 701/50

(57) ABSTRACT

A control system to dynamically control the operation of a work machine using information obtained from a remote entity includes a controller configured to determine a position of the work machine. The controller may also be configured to query a remote entity for information related to the position of the work machine. In addition, the controller may be configured to obtain the information in response to the query. The controller may also be configured to control at least one operation of the work machine based on the information received from the remote entity.

### TECHNICAL FIELD

The present disclosure is directed to a system and method for dynamic control of a work machine and, more particularly, to a system and method for dynamic control of a work machine based on information received from entities that are remotely located from a work machine.

### BACKGROUND

Work machines may be configured to operate in diverse geographical regions. A work machine may include a track-type tractor, truck, wheeled tractor, dump truck, automobile, on-highway vehicle, off-highway vehicle, skid-steer, stationary generator, or any other device that includes a power source. Depending on the need, a single work machine may be put into use in different geographical regions over a period of time. Each geographic region may have unique characteristics associated with the region. These characteristics may include, for example, the terrain of the region, environmental regulations associated with the region, safety regulations associated with the region, etc.

A work machine operating in a particular geographic region may have to modify its operation to adapt to the prevailing terrain in the region. Furthermore, the work machine may also have to modify its operation to comport with the environmental, safety, and other such regulations in that region. This is because, prior to entering the particular region, the work machine may have worked in a different geographic region where it was subject to different terrain and regulations. However, it may not be feasible for the operator of the work machine to proactively modify the operation of the work machine, because he may not be aware of the regulations prevalent in the particular geographic region. Furthermore, training work machine operators in regulations associated with different geographical regions and the associated requirements in operating a work machine may be a time-consuming and costly process. In addition, some portions of the terrain in which the work machine operates may not be visible to the operator of the work machine. This lack of visibility may lead to safety problems for the work machine and its operator.

Furthermore, some information associated with a particular geographic region may be transient in nature but nevertheless important for the operation of the work machine operating in that region. This information may include, for example, the ambient temperature and pressure at a site of work machine operation. In some situations, certain operations may or may not be performed when the work machine is operating at a certain temperature or pressure. For example, a regulatory authority may place more stringent emission control regulations pertaining to work machines when the work machines are operating below a certain ambient pressure. This may lead to a modification of certain control settings on a work machine such as, for example, an air-to-fuel ratio setting. In yet another example, an oil cooling pump on a work machine may have to be operated more frequently when the ambient temperature rises above a predetermined threshold in order to maintain the desired temperature of the oil.

In addition, the work machine may operate in a work area whose topography changes as the work machine travels from one portion of the work area to another. For example, a work machine may operate at a construction site constituting “hilly terrain” where operator safety and/or environmental regulations may specify that the work machine shall not operate above an average engine speed of 1000 rpm. While the work machine may not initially operate in what a regulatory authority has defined as “hilly terrain,” during a normal course of operation at the site, the work machine may enter “hilly terrain” where such regulations apply.

It may be difficult or impossible for the operator of the work machine to efficiently monitor this location-specific information, however, while operating the machine. Thus, it may be desirable to dynamically control a portion of the operation of a work machine based on location-specific information without the need for operator intervention.

While dynamic control of a portion of the operation of a work machine may be achieved by using information stored in an on-board device, such as, for example, a computer, there may be logistical constraints in relying solely on an on-board device for such information. For example, due to frequent changes in regulations and in ambient weather conditions, the on-board device may have to be updated frequently. Delays in updating the on-board device with the most up-to-date information pertaining to the work area of a work machine may increase the risk that the machine is operated inefficiently or in non-compliance with applicable regulations. In some instances, an immediate update of on-board devices may be difficult due to limitations, such as, for example, lack of personnel qualified to make the update, lack of equipment needed to make the update, etc. Therefore, it may be advantageous for work machines to have the ability to dynamically obtain, from off-board sources of information, the information necessary to efficiently operate in compliance with local conditions.

Thus, a need exists for systems and methods that facilitate the dynamic control of a work machine using off-board information. One related system and method is described in U.S. patent application Ser. No. 2003/0182026 by Awada et al. (“the '026 application”) that published on Sep. 25, 2003. The '026 application discloses a system and method for adaptively controlling a plurality of automotive control system (“ACS”) nodes of a vehicle based on the geographic position of the vehicle. Specifically, the '026 application describes a system wherein a GPS receiver provides the current geographic location of the vehicle to an ACS geographic processor. The ACS geographic processor compares the location information received from the GPS receiver with the location information found in geographic based control data that is stored in a nonvolatile memory device. The nonvolatile memory device contains a table of geographic points and a corresponding table of control data for each of the ACS nodes. When a match is found, the ACS geographic processor fetches corresponding operational data from the nonvolatile memory device and passes it to the corresponding ACS node. The ACS node then uses the received data in the operation of the system it is controlling.

While the system of the '026 publication may adaptively control the operation of ACS nodes based upon geographic location, it has several shortcomings. For example, the system of the '026 publication appears to require location-related information, that may be obtained from an off-board source, to be stored locally on a device on board the machine rather than on an entity that is located remotely from the machine. Thus, the system of the '026 publication may have access to only locally stored operational data. Therefore, the system of the '026 publication may require an update schedule and an update procedure to ensure that its location-related information stays current. Furthermore, because the system of the '026 publication may rely on location-related information that is only stored locally, the system may lack appropriate data for all regions where a machine may operate. For example, the machine, as part of its operation, may move into a region whose information is not stored on the on-board device. In addition, the system of the '026 publication may not have the ability to autonomously retrieve information as and when needed. While an on-board device may be updated with location-related information, an immediate update with such information may be difficult due to constraints such as, for example, lack of time, personnel, and equipment to make such updates. These shortcomings may affect the efficiency of the system described in the '026 publication.

The present disclosure is directed to overcoming one or more of the problems of the prior art location-based control system.

### SUMMARY OF THE INVENTION

In an exemplary embodiment, a control system to dynamically control the operation of a work machine using information obtained from a remote entity includes a controller configured to determine a position of the work machine. The controller may also be configured to query a remote entity for information related to the position of the work machine. In addition, the controller may be configured to obtain the information in response to the query. The controller may also be configured to control at least one operation of the work machine based on the information received from the remote entity.

In yet another exemplary embodiment, a control system to dynamically control the operation of a work machine may include a management system located remotely from the work machine, wherein the management system is configured to determine a position of the work machine. The management system may also be configured to query a remote entity for information related to the position of the work machine. The management system may also be configured to obtain the information in response to the query. The management system may also be configured to transmit the information received from the remote entity to a controller on the work machine, wherein the controller is configured to control at least one operation of the work machine based on the information.

In another exemplary embodiment, a method to dynamically control the operation of a work machine using information obtained from a remote entity includes determining a position of a work machine. The method also includes querying a remote entity for information related to the position of the work machine. The method also includes obtaining the information in response to the query. The method also includes affecting at least one operation of the work machine based on the information obtained from the remote entity.

Yet another exemplary embodiment includes a work machine. The work machine includes a frame and a power source operably connected to the frame. The work machine also includes a controller configured to determine a position of the work machine. The controller is also configured to query a remote entity for information related to the position of the work machine. The controller is also configured to obtain the information in response to the query. The controller is also configured to control at least one operation of the work machine based on the information received from the remote entity.

### BRIEF DESCRIPTION OF THE DRAWINGS

FIG. 1 is a pictorial representation of a work machine according to an exemplary disclosed embodiment.

FIG. 2 is a block diagram representation of a work machine control system according to an exemplary disclosed embodiment.

FIG. 3 is a block diagram representation of a work machine control system according to an alternative exemplary disclosed embodiment.

### DETAILED DESCRIPTION

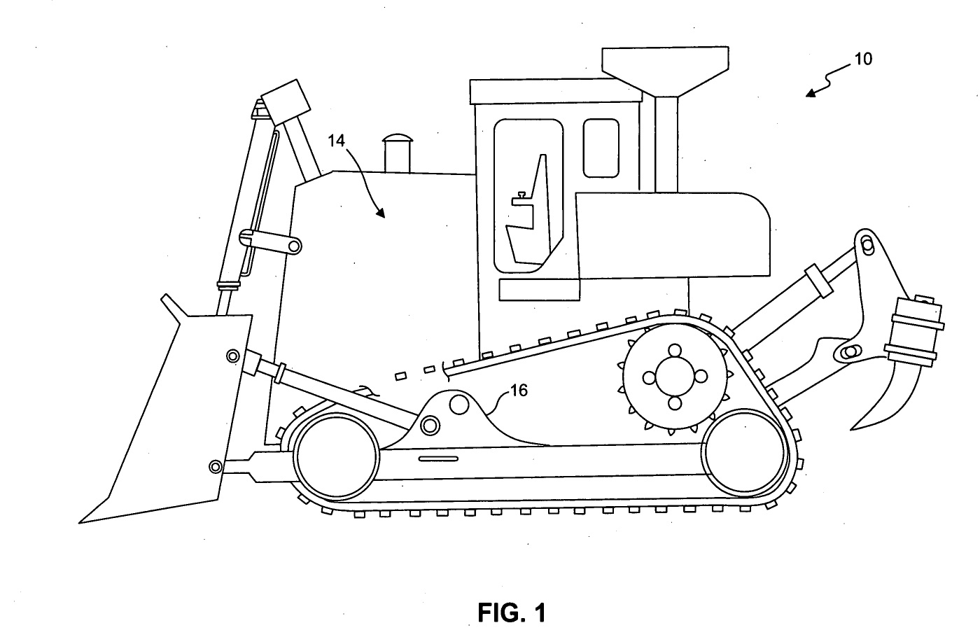

FIG. 1 provides a pictorial illustration of work machine 10. While work machine 10 is shown as a track type tractor, work machine 10 may include various other types of machines such as, for example, an on-highway truck, an off-highway truck, an automobile, a dump truck, a stationary generator, or any other such device that includes one or more machine components configured to respond to input commands from an operator.

Work machine 10 may include a power source 14 and frame 16. Power source 14 may include one or more devices configured to provide power for the operation of work machine 10. These devices may include, for example, an electric motor, an engine, a battery, etc. In an exemplary embodiment, power source 14 may include an engine such as, for example, a diesel engine, a gasoline engine, a steam engine, etc. In addition, any other engine configurable to provide power for the operation of work machine 10 may be used as power source 14. Power source 14 may be operatively coupled to frame 16.

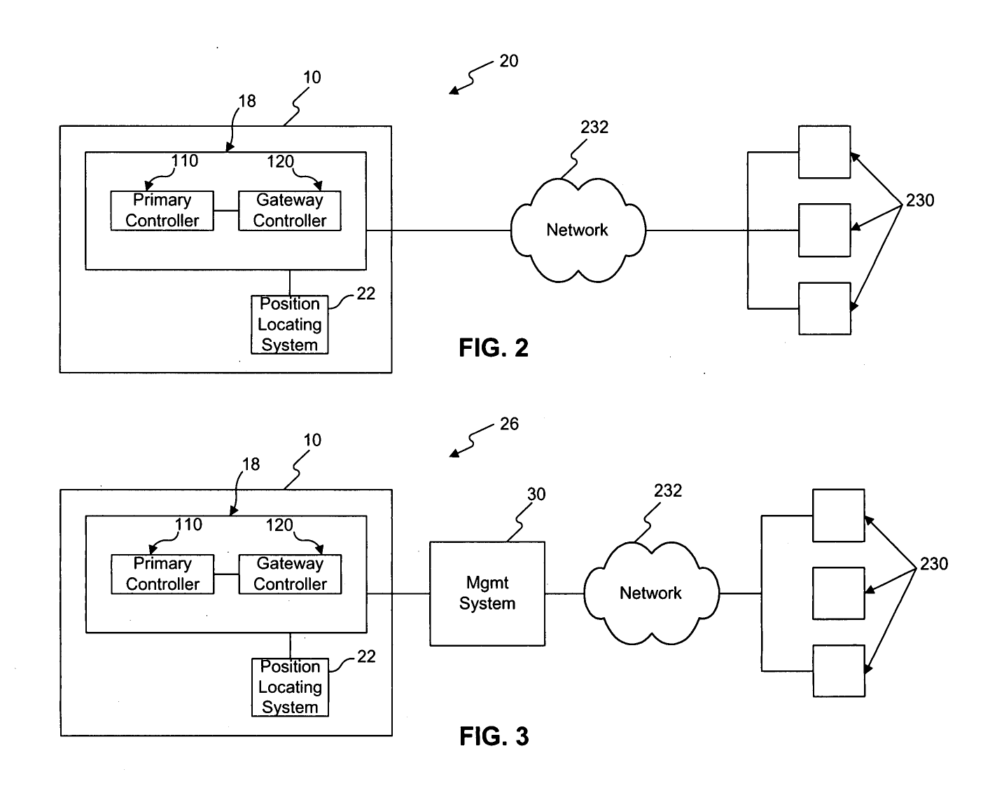

FIG. 2 provides a block diagram representation of control system 20 configured to dynamically control the operation of a work machine 10. Control system 20 may include a controller 18 and a position locating system 22 on work machine 10, one or more remote entities 230, and a network 232. Work machine 10 may include one or more communication components (not shown) for establishing a communication link between controller 18 and at least one remote entity 230 via network 232. Controller 18 may include primary controller 110 and gateway controller 120.

Some operations of work machine 10 may need modification to comport with the climatic conditions, terrain, and regulations specific to the region of operation of work machine 10. These operations may include, for example, the speed (including, for example, both machine over-ground speed and engine speed) at which work machine 10 may operate in a region, the type of braking system work machine 10 may use, the fuel-to-air ratio permissible for operation of work machine 10, etc. In addition, any other operational aspect of work machine 10 that may be related to the geographic region in work machine 10 is situated, may need modification in order to comport with the conditions in which work machine 10 is being operated.

In an exemplary embodiment, controller 18 may be configured to determine the position of work machine 10 from position locating system 22. Based on the position information received from position locating system 22, controller 18 may query one or more remote entities 230, via network 232, for information related to the position of work machine 10. Controller 18 may modify operational aspects of work machine 10 based on the location-specific information received from remote entities 230.

Position locating system 22 may be configured to provide position information relating to a geographic location of work machine 10. In one embodiment, position locating system 22 may be mounted onboard work machine 10 and may include a global positioning system (“GPS”) receiver. Based on signals from the GPS receiver, controller 18 may determine the position of work machine 10.

In another embodiment, position locating system 22 may include a transceiver configured to receive signals transmitted by a source other than a GPS. These signals may be used to determine position information related to work machine 10. For example, the transceiver may receive a signal from a cellular tower that broadcasts a location identifier over a limited range. Furthermore, the transceiver may receive one or more signals from a local rail line, radio station, air traffic control tower, other machines, machine management centers, etc., from which position information relating to work machine 10 may be determined or derived.

In another exemplary embodiment, instead of position locating system 22, an operator of work machine 10 may provide position information to controller 18. Specifically, an operator of work machine 10 may input this information by using an input device (not shown), such as, for example, a keyboard, mouse, etc.

Remote entities 230 may include one or more entities that include information related to the position and/or operation of work machine 10. Specifically, these entities may include information repositories that may be accessed by work machine 10 from any location, as long as work machine 10 has a connection to at least one remote entity 230. These information repositories may include electronic data storage devices, such as, for example, personal computers, Web servers, etc. Information included in remote entities 230 may include position-related information such as environmental data. Environmental data may include, for example, temperature, pressure, altitude, and topography related to the position of work machine 10. Remote entities 230 may also include information related to regulations, such as, for example, governmental regulations, that may be associated with the geographical position of work machine 10. Furthermore, remote entities 230 may also include information related to an operating procedure for a user of work machine 10, such as, for example, technical specifications related to work machine 10, an operator's manual for work machine 10, etc.

Remote entities 230 may include information repositories that include information obtained from a government entity, such as, for example, the state government, federal government, county government, and other such entities. Such information may include, for example, various environmental and safety regulations promulgated by a government that are related to the position of work machine 10. In addition, remote entities 230 may include information repositories that include information obtained from private entities, such as, for example, nonprofit entities, standards-related bodies, industry associations, commercial entities, etc. For example, information such as the ambient temperature and pressure at the location of work machine 10 may be determined from a Web site, such as www.weather.com. Furthermore, remote entities 230 may also include information repositories created by entities related to the manufacturing and operation of work machine 10. These entities may include, for example, the manufacturer of work machine 10, an independent parts supplier of work machine 10, an organization of users of work machine 10, etc. This list, however, is not exhaustive. Rather, any other entities that may include environmental data, data pertaining to regulations, and data pertaining to operating procedures for work machine 10 may be included in remote entities 230.

Work machine 10 may connect to at least one remote entity 230 through network 232. Network 232 may include one or more network devices that may be configured to facilitate the transfer of information between work machine 10 and remote entities 230. These devices may include, for example, PCs, firewalls, switches, routers, servers, repeaters, multiplexers etc.

Network 232 may be configured to provide work machine 10 with access to remote entities 230 through any connection means. In an exemplary embodiment, network 232 may be a publicly accessible communication network, such as, for example, the Internet, that may connect work machine 10 to remote entities 230. Alternatively, or in addition, network 232 may be configured to provide connectivity between work machine 10 and remote entities 230 through a private communication connection, such as, for example, a leased communication link (e.g., 56K connection, T1 connection, T3 connection, OC-3 connection, etc.). In addition, network 232 may be configured to provide work machine 10 with secure access to remote entities 230 by means of, for example, a Virtual Private Network (VPN). Work machine 10 may include various types of communication connections, such as, for example, a modem connection, wireless connection, coaxial cable connection, optical fiber connection, or any other connection, that may provide connectivity from work machine 10 to remote entities 230 via network 232.

Work machine 10 may use one or more on-board control devices to control the operations of work machine 10. These on-board devices may include, for example, controllers, actuators, relays, or any other electrical, mechanical, or electromechanical device configurable to control one or more operations of work machine 10. In an exemplary embodiment, work machine 10 may use controller 18 to obtain position information of work machine 10 from position locating system 22. Controller 18 may also be configured to query one or more remote entities 230 for information related to the position of work machine 10. Controller 18 may be further configured to change operational aspects of work machine 10 based on the information received from remote entities 230.

Controller 18 may include one or more components, including software, that may be configured to perform the operations noted above. Furthermore, controller 18 may include any devices suitable for running a software application. For example, controller 18 may include a CPU, RAM, I/O modules, etc. In an exemplary embodiment, all the components of controller 18 may be integrated into one physical unit to perform the functions noted above. In another exemplary embodiment, controller 18 may include two or more separate components that may be configured to perform, among other things, the above-mentioned functions.

As shown in FIG. 2, controller 18 on board work machine 10 may include two separate components—a primary controller 110 and a gateway controller 120. Primary controller 110 may be configured to control the operations of work machine 10. These operations may include, for example, regeneration of particulate traps, transmission control, braking system usage, etc.

Gateway controller 120 may be configured to provide, among other things, a connection between Work machine 10 and at least one remote entity 230. Furthermore, gateway controller 120 may be configured to connect to position locating system 22. Gateway controller 120 may receive position information related to work machine 10 from at least one of primary controller 110, an operator of work machine 10, and position locating system 22. Gateway controller 120 may be further configured to query one or more remote entities 230 for information related to the position of work machine 10. Gateway controller 120 may transmit this information to an operator and/or primary controller 110.

Querying may include a request for information sent by gateway controller 120 to at least one remote entity 230. This request may be made by gateway controller 120 using any appropriate means of communication. For example, if remote entity 230 is a Web server, then gateway controller 120 may send a request for information using Hyper Text Transfer Protocol (HTTP) data packets. Alternatively, if remote entity 230 is a File Transfer Protocol (“FTP”) server, gateway controller 120 may use FTP control packets such as a “get” packet to obtain information stored on the FTP server. In addition, other means for information requests that facilitate the transfer of information between remote entities 230 and gateway controller 120 may be used by gateway controller 120 to query remote entities 230.

Information received by gateway controller 120 in response to the query may be in any form suitable for use in controlling the operation of work machine 10. This information may include, for example, data, code, control settings, and/or applications.

In an exemplary embodiment, gateway controller 120 may operably connect to primary controller 110 using one or more connection means. These means may include wired connections, wireless connections, or any other means for connecting gateway controller 120 to primary controller 110. Wired connections may include copper, optical fiber, or other such connections. Gateway controller 120 may communicate with primary controller 110 using one or more communication protocols. These communication protocols may include datalink protocols and wireless protocols. Datalink protocols may include, for example, J1939, Ethernet, SAEJ1587, or other such protocols. Wireless protocols may include, for example, 802.11b, 802.11g, and other such protocols. In addition, gateway controller 120 may also communicate with position locating system 22 using any of the above-mentioned communication protocols.

Primary controller 110 may represent one or more devices that may be configured to control the operations of work machine 10. In an exemplary embodiment, primary controller 110 may include devices, such as, for example, an engine controller module, a regeneration controller module, a transmission controller module, a hydraulics control module, or any other device capable of controlling at least one operation of work machine 10.

As mentioned above, primary controller 110 may be used to control various operations of work machine 10. For example, primary controller 110 may be configured to control knocking in an engine. “Knocking” is uncontrolled fuel combustion detrimental to emissions, fuel economy, and engine longevity. Alternatively, primary controller 110 may include a regeneration controller to control the “regeneration” of an exhaust element in an exhaust system of a work machine. Regeneration is the process of heating the particulate matter trapped in an exhaust element to a temperature at which the particulate matter combusts or vaporizes.

In yet another instance, primary controller 110 may be configured to control the kind of braking system used in work machine 10. Specifically, work machine 10 may include multiple braking systems such as, for example, a service brake system, an engine brake system, an exhaust braking system, and a transmission braking system. Depending on the need and the regulations specific to the work site, an operator may be authorized to use only some of the braking systems available on work machine 10. For example, environmental regulations prevalent at a work site may prevent the use of an engine brake in a work machine. Primary controller 110 may therefore be configured to control the type of braking system that may be used on work machine 10 depending on the location of work machine 10. In addition, primary controller 110 may be configured to control other such operations of work machine 10.

Primary controller 110 may include components suitable for carrying out various operations for work machine 10. These components may include, for example, a memory (not shown) and a CPU (not shown), I/O modules (not shown), and any other component needed to run a program file. Furthermore, primary controller 110 may need data to perform its various functions. This data may include information, such as, for example, the regeneration duration for a particulate trap, the desired air-to-fuel ratio in the engine, the engine speed at which the engine in work machine 10 may operate, the type of braking system work machine 10 may use, etc. In an exemplary embodiment, a portion of the data may be stored in the memory of primary controller 110. Primary controller 110 may be configured to receive a portion of the data it uses to control the operation of work machine 10 from gateway controller 120.

Gateway controller 120 may include one or more devices configurable to, among other things, connect primary controller 110 to remote entities 230, query remote entities 230 for information related to the location of work machine 10, and pass data between primary controller 110 and remote entities 230. Furthermore, gateway controller 120 may also be configured to obtain position information from position locating system 22 or the operator of work machine 10. In an exemplary embodiment, gateway controller 120 may include programmable logic devices, such as, for example, PL300, PL1000e, and other electronic control devices configurable to transfer data from one communication port to another.

In an exemplary embodiment, gateway controller 120 may include different types of communication ports, such as, for example, serial ports, datalink ports, and Ethernet ports. On-board devices such as, for example, primary controller 110 and other off-board devices such as, for example, remote entities 230, may connect to communication ports on gateway controller 120. Gateway controller 120 may be configured to transfer information from one communication port to another. This information may include, for example, operational status information and/or location information of work machine 10 being sent from primary controller 110 and/or position locating system 22 to remote entities 230. In addition, gateway controller 120 may transfer information that may affect the operation of work machine 10, from one or more remote entities 230 to primary controller 110. Gateway controller 120 may be configured to use a software application to perform functions, such as, for example, querying one or more remote entities 230, transferring information between remote entities 230 and primary controller 110, translating data being transferred from one communication port to another, etc. This software application may be written in a computing language, such as, for example, C, C++, Pascal, Visual C++, or Visual Basic, etc. Furthermore, gateway controller 120 may include a CPU, RAM, I/O modules, any other component needed to run the software application.

In an exemplary embodiment, gateway controller 120 may be configured to connect to remote entities 230 using an Ethernet port. This Ethernet port may be configured to operate using, for example, a wireless communication protocol, such as, for example, 802.11b. Alternatively, any other known method of connecting an on-board controller to an off-board system may be used to connect gateway controller 120 to remote entities 230. In addition, gateway controller 120 may connect to primary controller 110 on a datalink port. Gateway controller 120 may communicate on the datalink port using a datalink protocol, such as, for example, J1939. In order to transfer data between remote entities 230 and primary controller 110, gateway controller 120 may be configured to translate information being transferred from the Ethernet port to the datalink port. In other words, gateway controller 120 may translate data from 802.11b protocol to J1939 and vice versa. This translation may be performed by the software application stored in a memory unit of gateway controller 120.

In an exemplary embodiment, in response to a query from gateway controller 120 to one or more remote entities 230, data received at the Ethernet port of gateway controller 120 from remote entities 230 may be stored in a memory unit associated with gateway controller 120. The CPU of gateway controller 120 may determine the port of exit for this received data. For example, the CPU of gateway controller 120 may determine that this received data is destined to exit gateway controller 120 through the datalink port connected to primary controller 110. Therefore, the CPU may translate the information from 802.11b to J1939 and transfer this information to the datalink port connected to primary controller 110. As mentioned above, the software application running in gateway controller 120 may perform the function of translating the information from one protocol to another. One skilled in the art will appreciate that a similar process of information translation of data from J1939 to 802.11b may be performed by gateway controller 120 to transfer data from primary controller 110 to remote entities 230.

While the embodiment discussed above describes gateway controller 120 being connected to primary controller 110 and at least one remote entity 230, one skilled in the art will appreciate that gateway controller 120 may connect to other devices and systems besides primary controller 110 and remote entities 230. For example, in an exemplary embodiment, gateway controller 120 may connect to a display device (not shown) and an input device (not shown) on work machine 10. The display device may be any known type of device that presents information to an operator on work machine 10. Thus, gateway controller 120 may, among other functions, display information received from primary controller 110, remote entities 230, and other such devices/systems to the display device. For example, gateway controller 120 may cache and display Web pages that are stored on primary controller 110, accessed through remote entities 230, or obtained via any other source, on the display device of work machine 10. The input device may include any device that may be used to transfer information from the operator to gateway controller 120, such as, for example, a keyboard, mouse, etc.

Furthermore, gateway controller 120 may also connect to a diagnostic device, such as, for example, a PC or laptop, that may be configured to monitor and configure gateway controller 120. In an exemplary embodiment, gateway controller 120 may use a datalink port, such as, for example, a J1939 port, to connect to a diagnostic device. In addition, other ports, such as a wireless port, optical fiber port, Ethernet port, serial port, etc., may be used to connect gateway controller 120 to a diagnostic device.

Any controllable function of work machine 10 may be controlled by primary controller 110 based on location-related information received from remote entities 230 via gateway controller 120. In an exemplary embodiment, primary controller 110 may be configured to affect the engine speed of work machine 10 based on the location of work machine 10. Specifically, gateway controller 120 may obtain the location information of work machine 10 from position locating system 22 or the operator of work machine 10. This location may be one wherein regulatory authorities have placed an engine speed limit of, for example, 1000 rpm on work machines (for reasons such as safety, etc.) such as work machine 10. Gateway controller 120 may query remote entity 230 for information related to the maximum engine speed at which work machine 10 may operate, given the current location of work machine 10. Upon receiving the engine speed limit information from remote entity 230, gateway controller 120 may transfer this information to primary controller 110. In turn, primary controller 110 may use this information to adjust an engine speed setting to ensure that work machine 10 does not operate over the engine speed limit of 1000 rpm.

One skilled in the art will appreciate that the embodiments described above are exemplary in nature only and other controllable operations of work machine 10 may also be controlled by primary controller 110 based on location-related information received from remote entities 230 via gateway controller 120.

One skilled in the art will also appreciate that while primary controller 110 and gateway controller 120 are disclosed as two physically separate components of controller 18, as noted above, primary controller 110 and gateway controller 120 may be part of one integrated unit of controller 100. In such an exemplary embodiment, all the functions described above that are performed separately by primary controller 110 and gateway controller 120 may, instead, be performed by the one integrated unit of controller 18.

FIG. 3 is a block diagram representation of an alternative work machine control system 26. Control system 26 is similar to control system 20 represented in FIG. 2, except that control system 26 includes a management system 30 remotely located with respect to work machine 10. Management system 30 provides a communication connection between work machine 10 and at least one remote entity 230 via network 232. The operation of work machine 10 may be modified with the help of management system 30. Specifically, work machine 10 may, among other information, send information relating to its position to management system 30. Management system 30 may query one or more remote entities 230 for information related to the position of work machine 10. Based on the information received from remote entities 230, management system 30 may transmit data to work machine 10 that may be used to affect the operation of work machine 10.

Management system 30 may be configured to dynamically affect the operation of work machine 10. Management system 30 may include components that obtain and store information that may be used to affect the operation of work machine 10. Specifically, management system 30 may include a computing device (not shown) that may connect to remote entities 230 through network 232. Furthermore, the computing device may connect to work machine 10. The computing device may include I/O ports, memory, CPU, and any other device suitable to run a software application. The computing device may be a device operated by a user, such as, for example, a laptop, desktop computer, mainframe, server, etc. In addition, any other device that includes interface ports, a processor, a memory unit, and any other component suitable for running a software application may be used as the computing device.

In addition to receiving location information from work machine 10, management system 30 may also obtain information related to the position of work machine 10 from remote entities 230. Specifically, management system 30 may be configured to query remote entities 230 for information related to the location of work machine 10. The query mechanisms used by management system 30 may be similar to those used by gateway controller 120, as described above. Based on the information received from remote entities 230 in response to the query, management system 30 may store and/or transmit information to work machine 10. This information may be used to affect the operation of work machine 10. This information may include environmental data, regulations, and operating procedures for a user of work machine 10, that are specific to the location of work machine 10.

In another exemplary embodiment, management system 30 may obtain position information of work machine 10 from positioning system 22 via gateway controller 120, for example. Alternatively, management system 30 may receive position information of work machine 10 from an operator of work machine 10 or an operator of management system 30.

Management system 30 may be configured to transfer information received from remote entities 230 to work machine 10. Specifically, management system 30 may store the received information in a memory unit associated with the computing device. Based on the stored information, a CPU in the computing device may use a software application to transfer at least a portion of the stored information to work machine 10. The software application used by the computing device may be configured as a computer program written in any type of computing language, such as, for example, C, C++, Pascal, Visual C++, or Visual Basic, etc. The information transferred may pertain to one or more operations of work machine 10. For example, the transferred information may include the maximum engine speed and over-ground speed at which work machine 10 may operate, the permissible fuel-to-air ratio for work machine 10, etc. Based on the information received from management system 30, any controllable operation of work machine 10 may be controlled by primary controller 110 by adjusting one or more control settings on primary controller 110.

Management system 30 may connect to at least one remote entity 230 through network 232. Management system 30 may also be used to obtain software files from remote entities 230 and transfer these software files to work machine 10. These software files may be used to change/update a program file running on primary controller 110. The resultant software change in primary controller 110 may affect the operation of work machine 10. For example, the received software update may result in modified algorithms for determining and controlling fuel mixture settings, engine speed, braking parameters, etc.

In yet another exemplary embodiment, management system 30 may be configured to provide backup data for faulty components on work machine 10, based on information received from remote entities 230. These components may, for example, include sensors that may provide information about the climatic conditions surrounding work machine 10 (e.g., temperature sensors, pressure sensors, etc). For example, if a temperature sensor on board work machine 10 becomes faulty, primary controller 110 may send a signal to management system 30 indicating the faulty status of the temperature sensor. Alternatively, the operator of work machine 10 may send a signal to management system 30 that an on-board temperature sensor is faulty. In response, management system 30 may query remote entities 230 for temperature information related to the location of work machine 10 and may obtain ambient temperature information from at least one remote entity 230. In this instance, remote entities 230 may include a Web site such as, for example, www.weather.com. Management system may provide the temperature information to work machine 10. In addition to temperature information, work machine 10 may obtain other information, such as ambient pressure, humidity, heat index, etc., on an “as needed” basis from remote entities 230 through management system 30.

### INDUSTRIAL APPLICABILITY

The disclosed embodiments may be useful for controlling the operation of any work machine having electronic control capabilities. These embodiments may provide improvements over the existing work machine control systems and methods. For example, in some instances, the same work machine may be used in different geographical regions and terrains. Therefore, the same work machine may be subject to different conditions, such as, for example, environmental and safety regulations, as it is moved from one location to another. In other instances, a work machine may, upon initial start up, require location-related information that is not readily available on board the work machine.

The disclosed system enables the work machine to query a remote entity for information related to the position of the work machine. In response to the query, the disclosed system enables the transfer of located-relation information from the remote entity to the work machine. By enabling the work machine to query a remote entity for position-related information, the disclosed system permits the work machine to obtain information as needed. Thus, a work machine using the disclosed system does not have to wait for an information update from an outside source. Rather, the work machine can proactively obtain location-related information.

Unlike prior art control systems that control a machine based on information stored in an on-board storage device, the disclosed system provides for on-board control of the work machine by using location-related information obtained from a remote entity. In addition, the disclosed system may recognize the need for certain information and autonomously retrieve the required information. This provides for a more robust and real time control for the work machine. Thus, the disclosed system ensures that the work machine has the capability to operate efficiently within the environmental conditions of a particular region. The disclosed system also ensures that the work machine has the capability to operate in compliance with local regulations and safety guidelines.

Furthermore, by affecting at least a portion of the operation of the work machine based on information obtained from a remote entity, the disclosed system may permit frequent updates to the information used to affect the operation of the work machine without interrupting the work schedule of the work machine. These frequent updates to information may help improve the dynamic control of the operation of the work machine without causing any service outages of the work machine.

It will be apparent to those skilled in the art that various modifications and variations can be made in the disclosed control system and method that uses off-board information without departing from the scope of the disclosure. Additionally, other embodiments of the disclosed system will be apparent to those skilled in the art from consideration of the specification. It is intended that the specification and the examples be considered exemplary only, with a true scope of the disclosure being indicated by the following claims and their equivalents.

What is claimed is:

1. A control system to dynamically control the operation of a work machine using information obtained from a remote entity, the system including:
a controller configured to:
determine a position of the work machine;
query a remote entity for information related to the position of the work machine;
obtain the information in response to the query; and
control at least one operation of the work machine based on the information obtained from the remote entity.

2. The control system of claim 1, wherein the controller includes a primary controller and a gateway controller;
the primary controller being configured to control the at least one operation of the work machine; and
the gateway controller being configured to determine the position of the work machine, query the remote entity for information related to the position of the work machine, obtain the information in response to the query, and transfer the information to the primary controller.

3. The control system of claim 2, wherein the gateway controller is configured to determine the position of the work machine based on information received from at least one of a position locating system and an operator of the work machine.

4. The control system of claim 3, wherein the position location system includes a global positioning system (“GPS”) receiver.

5. The control system of claim 1, wherein the information obtained includes at least one of environmental data, a regulation, and an operating procedure for the work machine.

6. The control system of claim 5, wherein the environmental data includes at least one of a temperature, pressure, altitude, and topography related to the position of the work machine.

7. The control system of claim 1, wherein the information obtained includes backup data to substitute for information not being generated by one or more faulty components on the work machine.

8. The control system of claim 2, wherein the primary controller is configured to control at least one of a fuel mixture setting, an engine speed setting, a regeneration setting, and a setting related to a braking system based on the information related to the position of the work machine.

9. A control system to dynamically control the operation of a work machine comprising:
a management system located remotely from the work machine, wherein the management system is configured to:
determine a position of the work machine;
query a remote entity for information related to the position of the work machine;
obtain the information in response to the query; and
transmit the information received from the remote entity to a controller on the work machine, wherein the controller is configured to control at least one operation of the work machine based on the information.

10. The control system of claim 9, wherein the controller includes a primary controller and a gateway controller, wherein the gateway controller is configured to communicate with the management system, and the primary controller is configured to control the at least one operation of the work machine based on the information received from the management system.

11. The control system of claim 9, wherein the management system is configured to determine the position of the work machine based on information received from at least one of a position locating system, an operator of the work machine, and an operator of the management system.

12. The control system of claim 11, wherein the position location system includes a global positioning system (“GPS”) receiver.

13. The control system of claim 9, wherein the information obtained from the remote entity includes at least one of environmental data, a regulation, and an operating procedure for the work machine.

14. The control system of claim 13, wherein the environmental data includes at least one of a temperature, pressure, altitude, and topography related to the position of the work machine.

15. A method to dynamically control the operation of a work machine using information obtained from a remote entity, the method including:
determining a position of a work machine;
querying a remote entity for information related to the position of the work machine;
obtaining the information in response to the query; and
affecting at least one operation of the work machine based on the information obtained from the remote entity.

16. The method of claim 15, wherein the information obtained includes at least one of environmental data, a regulation, and an operating procedure for the work machine.

17. The method of claim 15, further including determining the position of the work machine based on information received from at least one of a GPS system and an operator of the work machine.

18. The method of claim 16, wherein the environmental data includes at least one of a temperature, pressure, altitude, and topography related to the position of the work machine.

19. The method of claim 15, wherein the affecting the at least one operation of the work machine includes affecting adjustment of one or more control settings associated with one or more electronically controlled systems of the work machine.

20. The method of claim 19, wherein the one or more control settings include at least one of a fuel mixture setting, a speed setting, a regeneration setting, and a setting related to a braking system.

21. A work machine including:
a frame;
a power source operably connected to the frame; and
a controller configured to:
determine a position of the work machine;
query a remote entity for information related to the position of the work machine;
obtain the information in response to the query; and
control at least one operation of the work machine based on the information obtained from the remote entity.

22. The work machine of claim 21, wherein the controller is configured to determine the position of the work machine based on information received from at least one of a position locating system and an operator of the work machine.

23. The work machine of claim 22, wherein the position location system includes a global positioning system (“GPS”) receiver.

24. The work machine of claim 21, wherein the information received includes at least one of environmental data, a regulation, and an operating procedure for the work machine.
